(19) United States
(12) Patent Application Publication
(10) Pub. No.: US 2017/0350980 A1
(43) Pub. Date: Dec. 7, 2017

(54) ELECTRONIC DEVICE AND COMPUTER-READABLE RECORDING MEDIUM

(71) Applicant: FUJITSU LIMITED, Kawasaki-shi (JP)

(72) Inventors: Katsuyoshi YAMAGUCHI, Yokohama (JP); Masaki GENMA, Nakano (JP); Akira YONENAGA, Yokohama (JP); Teruki KOJIMA, Inagi (JP)

(73) Assignee: FUJITSU LIMITED, Kawasaki-shi (JP)

(21) Appl. No.: 15/684,846

(22) Filed: Aug. 23, 2017

Related U.S. Application Data
(63) Continuation of application No. PCT/JP2015/055714, filed on Feb. 26, 2015.

(51) Int. Cl. G01S 17/02; G06F 21/32

(52) U.S. Cl. CPC G01S 17/026; G06F 21/32; G06F 2221/2149

(57) ABSTRACT

An electronic device includes: a memory; a first infrared-ray emitter that emits a first infrared ray; a second infrared-ray emitter that emits a second infrared ray whose wavelength is partially overlapped with a wavelength of the first infrared ray; and a processor that is connected to the memory, the first infrared-ray emitter, and the second infrared-ray emitter. The processor is configured to determine whether an object is located in proximity to a device concerned during a proximity determination period based on a reflected light of the first infrared ray emitted, generate a capture image based on a reflected light of the second infrared ray emitted, conduct biometric authentication during an authentication period by using the capture image generated, and during the proximity determination period, stop emission of the second infrared ray or decrease an emission intensity of the second infrared ray from a reference level.

### CROSS-REFERENCE TO RELATED APPLICATION

This application is a continuation application of International Application No. PCT/JP2015/055714, filed on Feb. 26, 2015 and designating the U.S., the entire contents of which are incorporated herein by reference.

### FIELD

The embodiments discussed herein are related to an electronic device and a computer-readable recording medium.

### BACKGROUND

Some of electronic devices, such as mobile terminals, have the function to detect an object located in proximity. For example, there is a possibility that when a smartphone receives an incoming call, for instance, and a user holds the smartphone against his/her ear, the user's cheek touches the touch panel and the user's unintentional operation is received. Therefore, the smartphone sometimes performs a control so as to restrict operations on the touch panel except for a part of them when a sensor detects an object located in proximity upon an incoming call.

There are various methods as the method (hereafter, sometimes referred to as the “proximity detection method”) for detecting an object located in proximity; however, in terms of simplification, the method using infrared rays is typically used. According to the proximity detection method that uses infrared rays, the separate distance between the electronic device and the object is calculated based on the difference between the emission timing, in which an infrared ray is emitted, and the reception timing, in which the reflected wave of the infrared ray is received, and it is determined whether the object is located in proximity within a predetermined distance based on the calculated separate distance.

Patent Document 1: Japanese Laid-open Patent Publication No. 2009-254498

Furthermore, for the purpose of prevention of leak of personal information, or the like, many electronic devices, such as mobile terminals, have recently had a personal authentication function. Moreover, as a personal authentication method, there are methods that use biological information on iris, or the like. Hereafter, the authentication that uses the iris information is sometimes referred to as “iris authentication”.

For iris authentication, by using reflected waves of the emitted infrared rays, the iris pattern of the target to be authenticated is captured by an infrared camera, and if the captured iris pattern matches the previously stored iris pattern, “authentication success” is determined.

However, with regard to electronic devices that have an iris authentication function in addition to a proximity detection function, there is a possibility of occurrence of false detection on the object located in proximity. Specifically, in electronic devices that have an iris authentication function in addition to a proximity detection function, at least part of the wavelengths (i.e., frequencies) of infrared rays, used for the two functions, are sometimes overlapped. For example, the wavelength of a “first infrared ray”, used for the proximity detection function, is 850 nm, while the wavelength of a “second infrared ray”, used for the iris authentication function, is 800 nm to 900 nm. Furthermore, the emission intensity of the second infrared ray, used for the iris authentication function, is typically higher than the emission intensity of the first infrared ray, used for the proximity detection function. Therefore, with the electronic devices that have an iris authentication function in addition to a proximity detection function, there is a possibility of occurrence of false detection on an object located in proximity.

### SUMMARY

According to an aspect of the embodiments, an electronic device includes: a memory; a first infrared-ray emitter that emits a first infrared ray; a second infrared-ray emitter that emits a second infrared ray whose wavelength is partially overlapped with a wavelength of the first infrared ray; and a processor that is connected to the memory, the first infrared-ray emitter, and the second infrared-ray emitter. The processor is configured to determine whether an object is located in proximity to a device concerned during a proximity determination period based on a reflected light of the first infrared ray emitted, generate a capture image based on a reflected light of the second infrared ray emitted, conduct biometric authentication during an authentication period by using the capture image generated, and during the proximity determination period, stop emission of the second infrared ray or decrease an emission intensity of the second infrared ray from a reference level while the first infrared ray is emitted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram that illustrates an example of an electronic device according to a first embodiment;

FIG. 2 is a diagram that illustrates an example of the spectrum of a first infrared ray;

FIG. 3 is a diagram that illustrates an example of the spectrum of a second infrared ray;

FIG. 4 is a diagram that illustrates an example of the processing operation of the electronic device according to the first embodiment;

FIG. 5 is a flowchart that illustrates an example of the processing operation with regard to a proximity determination period of the electronic device according to the first embodiment;

FIG. 6 is a flowchart that illustrates an example of the processing operation with regard to an authentication period of the electronic device according to the first embodiment; and

FIG. 7 is a diagram that illustrates the exposure time adjustment according to a second embodiment.

### DESCRIPTION OF EMBODIMENT

Preferred embodiments will be explained with reference to accompanying drawings. Furthermore, the electronic device and the biometric authentication program, disclosed in the subject application, are not limited to the embodiments. Furthermore, in the embodiments, the components that have the same function are attached with the same reference numeral, and duplicated explanations are omitted.

### [a] First Embodiment

Example of the configuration of the electronic device

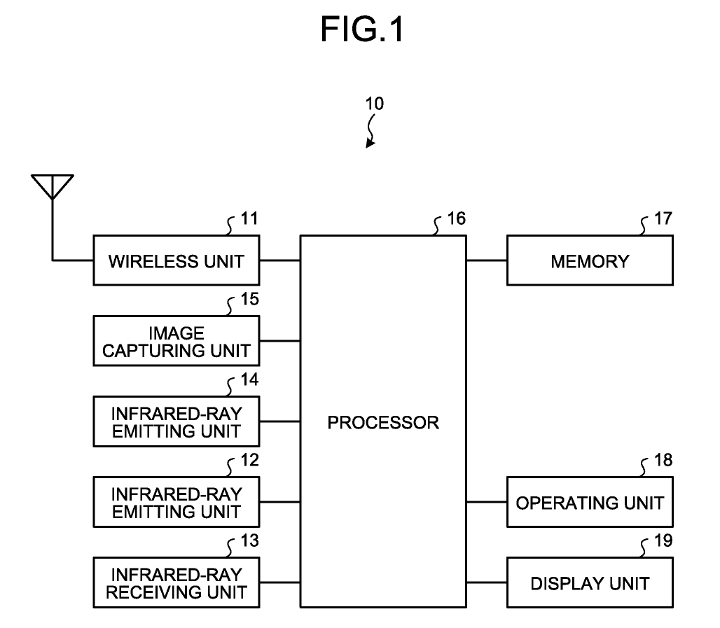

FIG. 1 is a diagram that illustrates an example of an electronic device according to a first embodiment. An electronic device 10 is for example a mobile terminal, and an explanation is given below based on the assumption that the electronic device 10 is a mobile terminal. In FIG. 1, the electronic device 10 includes a wireless unit 11, infrared-ray emitting units 12, 14, an infrared-ray receiving unit 13, an image capturing unit 15, a processor 16, a memory 17, an operating unit 18, and a display unit 19. The electronic device 10 cancels “process restriction” if the authentication based on “biological information” succeeds. The “biological information” is, for example, face information or iris information. The “process restriction” is, for example, a restriction on the shift from the idle screen status to the subsequent screen status in the display status of the display unit 19 in the electronic device 10. Furthermore, an explanation is given below based on the assumption that the “biological information” is iris information.

The wireless unit 11 receives radio signals, transmitted from a communication device at the other end of the communication, via an antenna, performs a predetermined wireless reception process (down-conversion, analog-digital conversion, or the like) on the received radio signals, and outputs the obtained reception signals to the processor 16. Furthermore, the wireless unit 11 performs a predetermined wireless transmission process (digital-analog conversion, up-conversion, or the like) on transmission signals, received from the processor 16, and transmits the obtained radio signals via the antenna.

The infrared-ray emitting unit 12 emits (outputs) the above-described “first infrared ray” in accordance with a control of the processor 16. Hereafter, the infrared-ray emitting unit 12 is sometimes referred to as a “first infrared-ray output unit”.

The infrared-ray emitting unit 14 emits the above-described “second infrared ray” in accordance with a control of the processor. Hereafter, the infrared-ray emitting unit 14 is sometimes referred to as a “second infrared-ray output unit”.

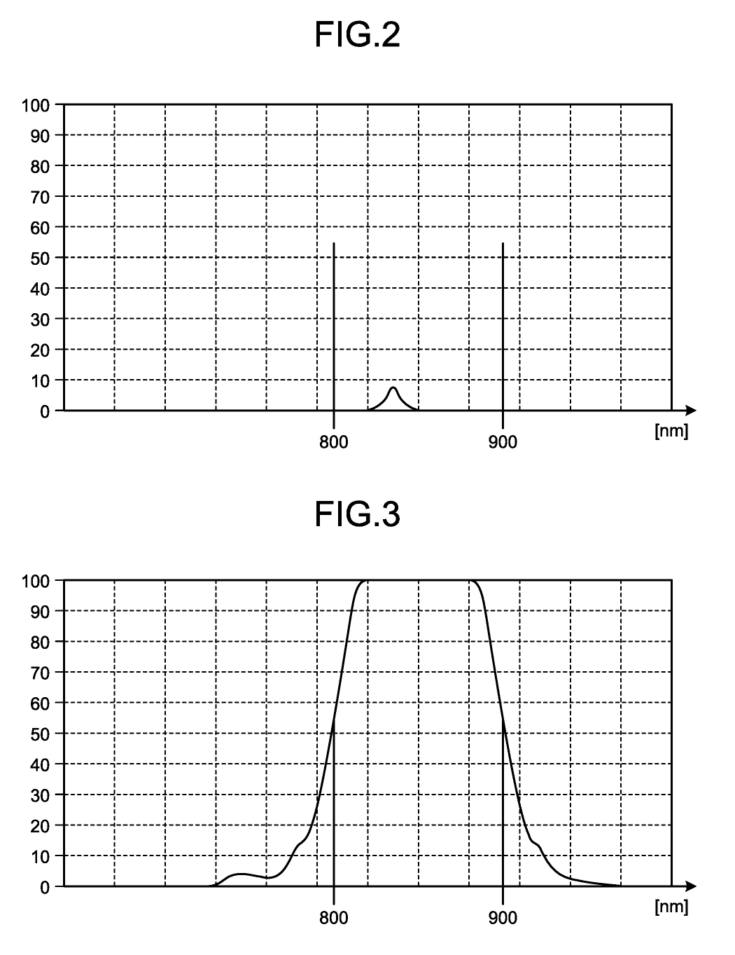

FIG. 2 is a diagram that illustrates an example of the spectrum of the first infrared ray. FIG. 3 is a diagram that illustrates an example of the spectrum of the second infrared ray. As illustrated in FIG. 2, the wavelength of “the first infrared ray”, used for the proximity detection function, is 850 nm. Conversely, as illustrated in FIG. 3, the wavelength of “the second infrared ray”, used for the iris authentication function, is 800 nm to 900 nm. That is, the wavelength of “the second infrared ray” is partially overlapped with the wavelength of “the first infrared ray”. Furthermore, the intensity (hereafter, sometimes referred to as the “reference level”) of “the second infrared ray” in the vicinity of 850 nm is about ten times as high as the intensity of “the first infrared ray”.

With reference back to FIG. 1, the infrared-ray receiving unit 13 receives a reflected wave of the first infrared ray, emitted from the infrared-ray emitting unit 12, and outputs a “light receiving timing” to the processor 16.

The image capturing unit 15 receives a reflected wave of the second infrared ray, emitted from the infrared-ray emitting unit 14, and outputs “captured-image data” based on the received reflected wave to the processor 16.

The operating unit 18 receives a user's operation and outputs the information about the received operation to the processor 16. The display unit 19 presents the display image, which corresponds to the display data that is received from the processor 16, in accordance with a control of the processor 16. The operating unit 18 and the display unit 19 are implemented by using, for example, a touch panel.

The processor 16 controls the overall operation of the electronic device 10. With regard to various types of processing functions that are performed by the processor 16, they are performed when a program, corresponding to each process, is recorded in a memory 17, and each program is executed by the processor 16. Examples of the processor 16 include a CPU, a digital signal processor (DSP), or a field programmable gate array (FPGA). Examples of the memory 17 include a random access memory (RAM), such as a synchronous dynamic random access memory, a read only memory (ROM), or a flash memory.

For example, the processor 16 causes the infrared-ray emitting unit 12, which is the first infrared-ray output unit, to emit the first infrared ray that has a first wavelength (here, 850 nm) during a “proximity determination period” and acquires an “emission timing”. The “proximity determination period” is repeated at for example a “first cycle”. Furthermore, the processor 16 acquires “the light receiving timing” in which the infrared-ray receiving unit 13 receives the reflected wave of the emitted first infrared ray. Then, based on “the emission timing” and “the light receiving timing”, the processor 16 determines whether an object is located in proximity to the electronic device 10. For example, the processor 16 calculates the separate distance between the electronic device 10 and the object in accordance with the difference between “the emission timing” and “the light receiving timing” and, based on the calculated separate distance, determines whether the object is located in proximity within a predetermined distance.

Furthermore, the processor 16 causes the infrared-ray emitting unit 14, which is the second infrared-ray output unit, to emit the second infrared ray that has a second wavelength (here, 800 nm to 900 nm) during “the authentication period”. The reflected wave of the emitted second infrared ray is received by the image capturing unit 15. Then, the processor 16 receives the captured-image data from the image capturing unit 15 and generates a capture image based on the received captured-image data. Then, the processor 16 conducts biometric authentication by using the generated capture image.

Here, the length of the single authentication period is longer than the length of the single proximity determination period. Furthermore, if the proximity determination period is included in the authentication period, the processor 16 causes the first infrared ray to be emitted during the proximity determination period while it performs a control so as to stop emission of the second infrared ray. That is, emission of the second infrared ray is stopped when the first infrared ray is emitted.

Furthermore, the processor 16 performs a control so as not to start the authentication period if it is determined that an object is located in proximity to the device concerned in the proximity determination period before the authentication period is started and so as to start the authentication period if it is determined that an object is not located in proximity to the device concerned in the proximity determination period before the authentication period is started.

Operation example of the electronic device

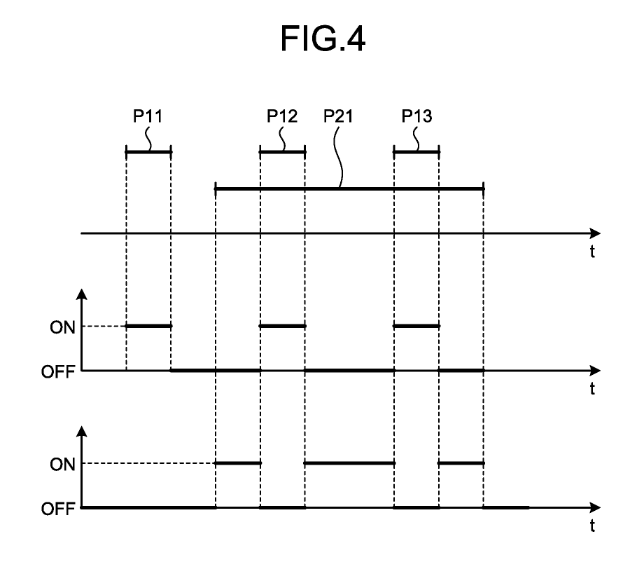

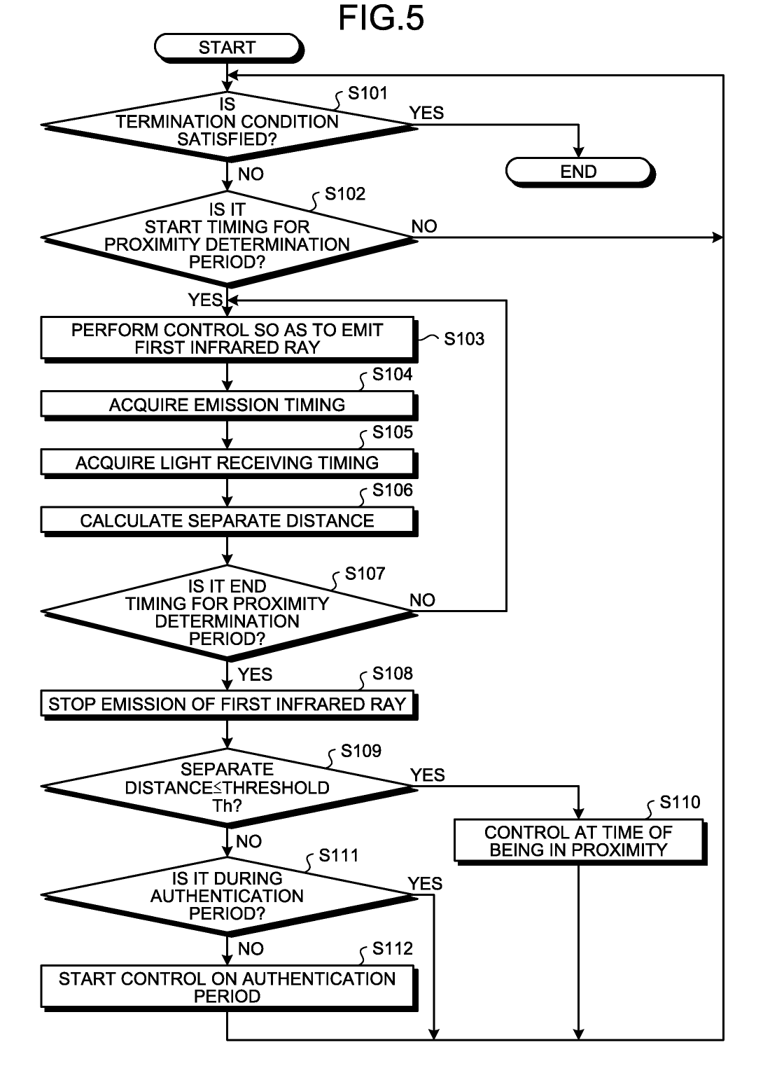

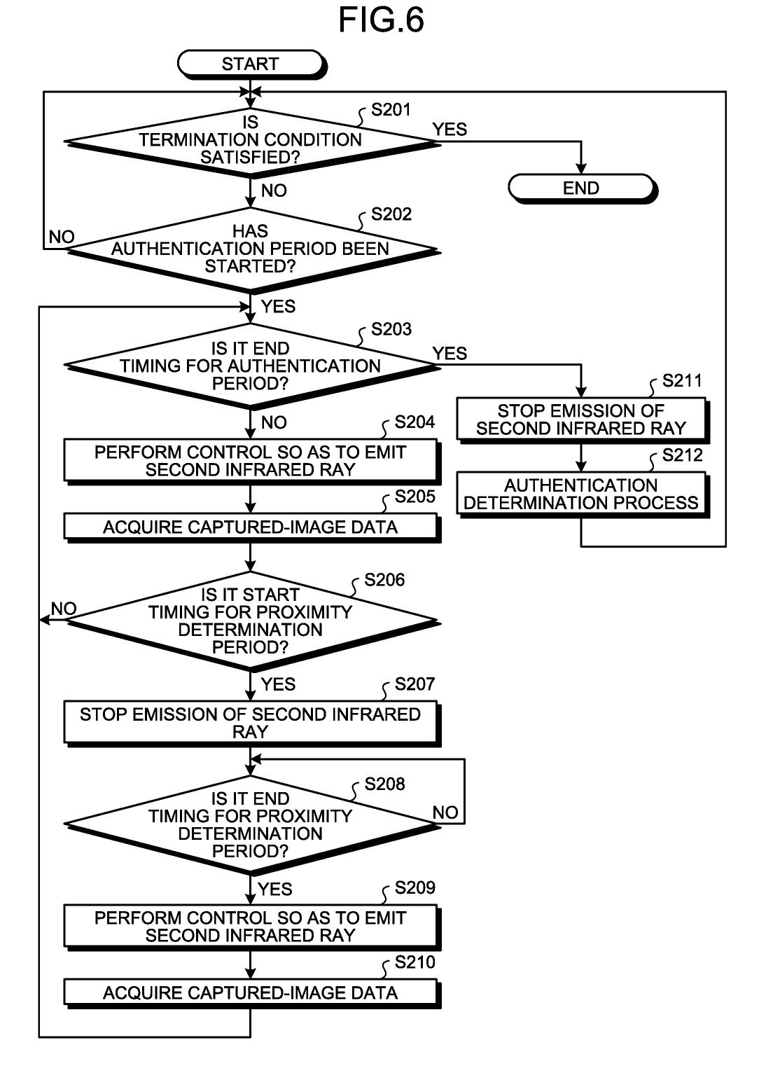

An explanation is given of an example of the processing operation of the electronic device 10 that has the above-described configuration. FIG. 4 is a diagram that illustrates an example of the processing operation of the electronic device according to the first embodiment. The upper section of FIG. 4 illustrates an example of appearances of the authentication period and the proximity determination period. Furthermore, the middle section of FIG. 4 illustrates the emission period and the stop period of the first infrared ray. Furthermore, the lower section of FIG. 4 illustrates the emission period and the stop period of the second infrared ray. FIG. 5 is a flowchart that illustrates an example of the processing operation with regard to the proximity determination period of the electronic device according to the first embodiment. FIG. 6 is a flowchart that illustrates an example of the processing operation with regard to the authentication period of the electronic device according to the first embodiment.

Example of the processing operation with regard to the proximity determination period

The processor 16 determines whether a termination condition is satisfied (Step S101). The termination condition is that, for example, the power of the electronic device 10 is turned off. If the termination condition is satisfied (Yes at Step S101), the process flow is terminated.

If the termination condition is not satisfied (No at Step S101), the processor 16 determines whether the start timing for the proximity determination period has come (Step S102). If the start timing for the proximity determination period has not come (No at Step S102), the process step returns to Step S101.

If the start timing for the proximity determination period has come (Yes at Step S102), the processor 16 performs a control on the infrared-ray emitting unit 12 so as to emit the first infrared ray (Step S103). That is, the first infrared ray is emitted when any proximity determination period is started among proximity determination periods P11, P12, and P13 in FIG. 4.

The processor 16 acquires the emission timing of the first infrared ray from the infrared-ray emitting unit (Step S104).

The processor 16 acquires the light receiving timing of the reflected wave of the first infrared ray from the infrared-ray receiving unit 13 (Step S105).

The processor 16 calculates the separate distance between the electronic device 10 and the object based on the emission timing and the light receiving timing that are acquired (Step S106).

The processor 16 determines whether the end timing for the proximity determination period has come (Step S107). If the end timing for the proximity determination period has not come (No at Step S107), the process step returns to Step S103.

If the end timing for the proximity determination period has come (Yes at Step S107), the processor 16 stops the infrared-ray emitting unit 12 from emitting the first infrared ray (Step S108). That is, emission of the first infrared ray is stopped when any proximity determination period ends among the proximity determination periods P11, P12, and P13 in FIG. 4.

The processor 16 determines whether the separate distance, calculated at Step S106, is equal to or less than a threshold Th (Step S109).

If the separate distance is equal to or less than the threshold Th (Yes at Step S109), the processor 16 performs a control at the time of proximity (Step S110). The control at the time of proximity is, for example, the above-described “control to restrict operations on the touch panel except for a part of them”. Here, if the separate distance is equal to or less than the threshold Th (Yes at Step S109), the authentication period is not started. Thus, if it is estimated that the user is located close to the electronic device 10, the second infrared ray, which has a high output power, is prevented from being output. As a result, safety for users may be improved.

If the separate distance is more than the threshold Th (No at Step S109), the processor 16 determines whether it is during the authentication period (Step S111). If it is during the authentication period (Yes at Step S111), the process step returns to Step S101. That is, in the case of the proximity determination periods P12, P13 in FIG. 4, the process step returns to Step S101.

If it is not during the authentication period (No at Step S111), the processor 16 starts the control on the authentication period (Step S112). Specifically, if it is determined that the separate distance is more than the threshold Th during the proximity determination period P11 in FIG. 4, the authentication period is started.

Example of the processing operation with regard to the authentication period

The processor 16 determines whether the termination condition is satisfied (Step S201). The termination condition is, for example, that the power of the electronic device 10 is turned off. If the termination condition is satisfied (Yes at Step S201), the process flow is terminated.

If the termination condition is not satisfied (No at Step S201), the processor 16 determines whether the authentication period has been started (Step S202). If the authentication period has not been started (No at Step S202), the process step returns to Step S201.

If the authentication period has been started (Yes at Step S202), the processor 16 determines whether the end timing for the authentication period has come (Step S203).

If the end timing for the authentication period has not come (No at Step S203), the processor 16 performs a control on the infrared-ray emitting unit 14 so as to emit the second infrared ray (Step S204). That is, as illustrated in FIG. 4, emission of the second infrared ray is started in accordance with the start of an authentication period P21.

The processor 16 acquires the captured-image data based on the reflected wave of the second infrared ray from the image capturing unit 15 (Step S205).

The processor 16 determines whether the start timing for the proximity determination period has come (Step S206). If the start timing for the proximity determination period has not come (No at Step S206), the process step returns to Step S203.

If the start timing for the proximity determination period has come (Yes at Step S206), the processor 16 stops the infrared-ray emitting unit 14 from emitting the second infrared ray (Step S207). That is, emission of the second infrared ray is stopped during the proximity determination periods P12, P13 in FIG. 4. Thus, interference of the second infrared ray with the first infrared ray may be reduced, and the possibility of occurrence of false detection on the object being located in proximity may be reduced.

The processor 16 determines whether the end timing for the proximity determination period has come (Step S208). This process step is repeated until the end timing for the proximity determination period comes (No at Step S208).

If the end timing for the proximity determination period has come (Yes at Step S208), a control is performed on the infrared-ray emitting unit 14 so as to emit the second infrared ray (Step S209). That is, as illustrated in FIG. 4, emission of the second infrared ray is conducted during the period that is not overlapped with the proximity determination periods P12, P13 in the authentication period P21.

The processor 16 acquires the captured-image data based on the reflected wave of the second infrared ray from the image capturing unit 15 (Step S210).

Conversely, if the end timing for the authentication period has come (Yes at Step S203), the processor 16 stops emission of the second infrared ray (Step S211).

The processor 16 uses the capture image, which is generated from the captured-image data that is acquired during the authentication period, to perform “biometric determination process”, i.e., biometric authentication (Step S212).

As described above, according to the present embodiment, in the electronic device 10, the processor 16 causes the first infrared ray to be emitted during the proximity determination period while it stops emission of the second infrared ray.

With the configuration of the electronic device 10, the interference of the second infrared ray with the first infrared ray may be reduced, and therefore the possibility of occurrence of false detection on the object being located in proximity may be reduced.

Furthermore, if it is determined that the object is located in proximity to the device concerned during the proximity determination period before the authentication period is started, the processor 16 does not start the authentication period and, if it is determined that the object is not located in proximity to the device concerned during the proximity determination period before the authentication period is started, starts the authentication period.

With the configuration of the electronic device 10, it is possible to prevent the second infrared ray from being emitted in a state where a user is located very close to the electronic device 10; thus, it is possible to prevent user's eyes from being damaged by the second infrared ray.

Furthermore, although it is explained in the above explanations that, if the proximity determination period is included in the authentication period, the processor 16 stops emission of the second infrared ray while the first infrared ray is emitted during the proximity determination period, this is not a limitation. For example, the processor 16 may perform a control so as to decrease the emission intensity of the second infrared ray from the above-described “reference level” while the first infrared ray is emitted. In this case, the processor 16 sets, for example, the emission intensity of the second infrared ray to be lower than the emission intensity of the first infrared ray. With the configuration of the electronic device 10, too, the interference of the second infrared ray with the first infrared ray may be reduced, and therefore the possibility of occurrence of false detection on the object being located in proximity may be reduced.

### [b] Second Embodiment

A second embodiment relates to the control on exposure time adjustment of the image capturing unit. Here, as the basic configuration of the electronic device according to the second embodiment is the same as that of the electronic device 10 according to the first embodiment, an explanation is given by using FIG. 1.

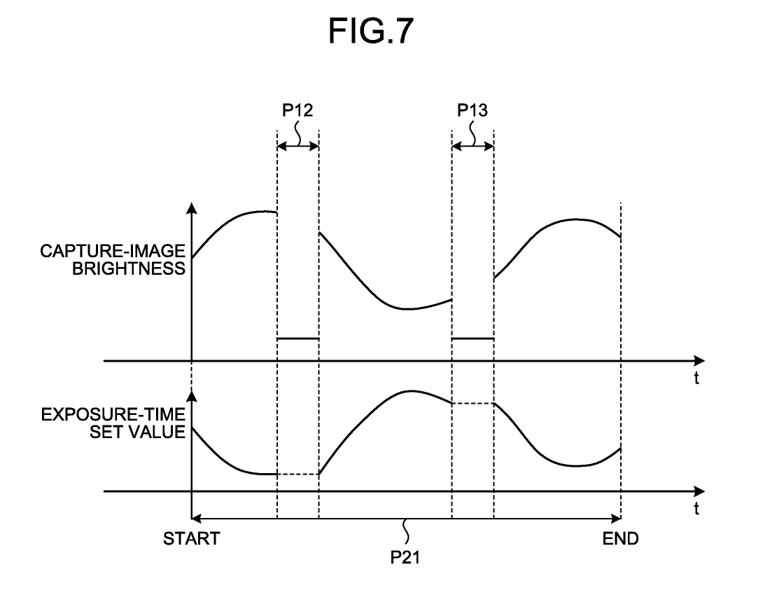

If the second infrared ray is emitted, the processor 16 in the electronic device 10 according to the second embodiment adjusts the exposure time of the image capturing unit 15 in accordance with the brightness of the generated capture image. Specifically, as illustrated in FIG. 7, during the period that is not overlapped with the proximity determination periods P12, P13 in the authentication period P21, the processor 16 adjusts the exposure time of the image capturing unit 15 in accordance with the brightness of the generated capture image. For example, the processor 16 decreases the exposure time as the brightness of the capture image is higher. That is, the processor 16 increases the exposure time as the brightness of the capture image is lower.

Conversely, if the second infrared ray is not emitted, the processor 16 sets the exposure time of the image capturing unit 15 to be the “reference value”. If the proximity determination period is included in the authentication period, the exposure time, which is adjusted in the authentication period before the proximity determination period is started, is used as the “reference value”. Specifically, for example, in FIG. 7, the exposure time, which is used during the proximity determination period P12, is adjusted immediately before the proximity determination period P12 is started. FIG. 7 is a diagram that illustrates the exposure time adjustment according to the second embodiment. The upper section of FIG. 7 illustrates the temporal transition of the brightness of the capture image. Furthermore, the lower section of FIG. 7 illustrates the temporal transition of the set value for the exposure time.

As described above, according to the present embodiment, in the electronic device 10, if the second infrared ray is not emitted, the processor 16 sets the exposure time of the image capturing unit to the reference value and, if the second infrared ray is emitted, adjusts the exposure time of the image capturing unit in accordance with the brightness of the capture image. For example, if the proximity determination period is included in the authentication period, the processor 16 uses, as the above-described reference value, the exposure time that is adjusted in the authentication period immediately before the proximity determination period is started.

With the configuration of the electronic device 10, adjustment on the exposure time may be avoided during the period in which the second infrared ray is not emitted and in which there is a high possibility that the exposure time of the image capturing unit is not adjusted to an appropriate value even if it is adjusted in accordance with the brightness of the capture image.

According to the disclosed aspect, the possibility of occurrence of false detection on the object being located in proximity may be reduced.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a memory;
a first infrared-ray emitter that emits a first infrared ray;
a second infrared-ray emitter that emits a second infrared ray whose wavelength is partially overlapped with a wavelength of the first infrared ray; and
a processor that is connected to the memory, the first infrared-ray emitter, and the second infrared-ray emitter, wherein
the processor is configured to
determine whether an object is located in proximity to a device concerned during a proximity determination period based on a reflected light of the first infrared ray emitted,
generate a capture image based on a reflected light of the second infrared ray emitted,
conduct biometric authentication during an authentication period by using the capture image generated, and
during the proximity determination period, stop emission of the second infrared ray or decreases an emission intensity of the second infrared ray from a reference level while the first infrared ray is emitted.

2. The electronic device according to claim 1, wherein when the second infrared ray is not emitted, the processor is further configured to set an exposure time of an image censor to a reference value and, when the second infrared ray is emitted, adjust the exposure time of the image censor in accordance with a brightness of the capture image generated.

3. The electronic device according to claim 2, wherein in a case where the proximity determination period is included in the authentication period, the processor is further configured to use, as the reference value, the exposure time that is adjusted in the authentication period before the proximity determination period is started.

4. The electronic device according to claim 1, wherein when it is determined that an object is located in proximity to a device concerned in the proximity determination period before the authentication period is started, the processor is further configured not to start the authentication period and, when it is determined that an object is not located in proximity to the device concerned in the proximity determination period before the authentication period is started, the processor is further configured to start the authentication period.

5. A non-transitory computer-readable recording medium storing a biometric authentication program that causes a computer to execute a process comprising:
emitting a first infrared ray;
emitting a second infrared ray whose wavelength is partially overlapped with a wavelength of the first infrared ray;
determining whether an object is located in proximity during a proximity determination period based on a reflected light of the first infrared ray emitted;
generating a capture image based on a reflected light of the second infrared ray emitted;
conducting biometric authentication during an authentication period by using the capture image generated; and
during the proximity determination period, stopping emission of the second infrared ray or decreasing an emission intensity of the second infrared ray from a reference level while the first infrared ray is emitted.
